(19) United States
(12) Patent Application Publication
(10) Pub. No.: US 2026/0071693 A1
(43) Pub. Date: Mar. 12, 2026

(54) INTELLIGENT VALVE SYSTEMS AND METHODS

(71) Applicant: MidCentral Energy Partners, LLC, Oklahoma City, OK (US)

(72) Inventors: Mark Dille, Magnolia, TX (US); Nathan Dronberger, Yukon, OK (US)

(73) Assignee: MidCentral Energy Partners, LLC, Oklahoma City, OK (US)

(21) Appl. No.: 19/320,619

(22) Filed: Sep. 5, 2025

Related U.S. Application Data
(60) Provisional application No. 63/691,511, filed on Sep. 6, 2024.

(51) Int. Cl. F16K 37/00; F16K 17/10

(52) U.S. Cl. CPC F16K 37/0041; F16K 17/105

(57) ABSTRACT

An intelligent valve system and methods are disclosed for releasing pressure from a main fluid line that defines a primary fluid flow path. In one aspect, the intelligent valve system includes a pressure relief valve system having a pressure relief block connected to the main fluid line, a first pressure relief valve coupled to the pressure relief block, and a second pressure relief valve coupled to the first pressure relief valve, where the pressure relief valves define an alternative fluid flow path that extends approximately perpendicular to the primary fluid flow path. The intelligent valve system may also include a bleed down valve system having a bleed down block, a first bleed down valve coupled to the bleed down block, and a second bleed down valve coupled thereon. The bleed down valves define a flow path that extends approximately perpendicular to the primary fluid flow path.

### CROSS REFERENCE TO RELATED APPLICATIONS

This application claims the benefit of U.S. Provisional Patent Application No. 63/691,511 filed Sep. 6, 2024, and incorporates said provisional application by reference into this document as if fully set out at this point.

### FIELD OF THE INVENTION

The present invention generally relates to systems and methods used in the oil and gas industry and more particularly, but not by way of limitation, to systems and methods related to wellhead valve control systems for oil and gas wells.

### BACKGROUND OF THE INVENTION

Hydraulic fracturing systems feature numerous pipes and valves connected to a central manifold. The central manifold links surface pumps with wellhead devices to deliver high-pressure fracturing fluid downhole into wells during fracturing operations. To control fluid flow into or out of the wells, a hydraulic fracturing system may use a wellhead control system that includes wireless or wired control systems, check valves, gate valves, piping, transducers, and the like. In facilitating fluid flow, the central manifold is subjected to high internal pressures that pose a relatively high safety risk. During operations, relief valves may be used to exhaust pressure within the hydraulic fracturing system when the internal pressure exceeds the maximum allowable operating thresholds. Bleed valves may also be used to relieve pressure in a controlled fashion from a charged system in a static state. These valve systems may greatly reduce the operational risks and incidence of accidents at hydraulic fracturing sites.

Traditional relief and bleed valve systems utilize independent valves and skid systems for pressure management. These systems allow sand and dirt from fracturing operations to build up ahead of the valves, severely reducing their effective life and incurring damage as the valves cycle open and closed. De-sanding these valve systems often requires the implementation of designated filters and/or manual intervention and cleaning, and the downtime required for maintenance is both costly and time-consuming. Traditional relief valves systems are also difficult to access in the case of an emergency event.

There is, therefore, a need for improved systems and methods that overcome the deficiencies in the prior art.

### SUMMARY OF THE INVENTION

The inventive concepts disclosed are generally directed to an intelligent valve system and methods for reducing pressure levels with a hydraulic fracturing system.

In one aspect, an intelligent valve system is disclosed that is configured for placement along a main fluid line of a hydraulic fracturing system, where the main fluid line defines a primary fluid flow path. The intelligent valve system includes a pressure relief valve system for releasing pressure from the main fluid line. The pressure relief valve system uses a pressure relief block connected to the main fluid line, and may include a first pressure relief valve coupled to the pressure relief block, and a second pressure relief valve coupled to the first pressure relief valve, wherein the first pressure relief valve and the second pressure relief valve define an alternative fluid flow path that extends approximately perpendicular to the primary fluid flow path.

In an embodiment, the first pressure relief valve and the second pressure relief valve are gate valves.

In an embodiment, the first pressure relief valve and the second pressure relief valve are normally open gate valves.

In an embodiment, the pressure relief valve system also includes a fluid relief conduit that connects the second pressure relief valve to a pressure relief outlet.

In an embodiment, the pressure relief valve system is configured for installation upstream from a check valve of the main fluid line.

In an embodiment, the pressure relief valve system may include additional pressure relief valves in series with the first pressure relief valve and the second pressure relief valve.

In an embodiment, the pressure relief valve system may include a single pressure relief valve.

In an embodiment, the one or more pressure relief valves may be connected to the pressure relief block in an approximately horizontal configuration

In an embodiment, the pressure relief valve system is supported by a structural skid.

In an embodiment, either the first pressure relief valve or the second pressure relief valve is positioned as a closed-configuration valve under standard pressurization conditions.

In an embodiment, the pressure relief valve system also includes a pressure relief transducer configured to measure pressure levels within the pressure relief block.

In an embodiment, the intelligent valve system also includes a control system having a memory and a software module stored in the memory. The software module houses executable instructions that, when executed by the processor, cause the processor to receive signals from the pressure relief transducer that represent the measured pressure level, compare the measured pressure level from the pressure relief transducer to a predetermined pressure threshold, and trigger opening of the closed-configuration relief valve when the measured pressure level exceeds the predetermined pressure threshold.

In an embodiment, the executable instructions, when executed by the processor, further cause the processor to receive signals from the pressure relief transducer that represent the resulting pressure level after the first pressure relief valve and the second pressure relief valve are opened, and trigger closing of either the first pressure relief valve or the second pressure relief valve when the measured pressure level is lower than the predetermined pressure threshold.

In an embodiment, the intelligent valve system also includes a bleed down valve system for venting residual pressure from the main fluid line. The bleed down valve system comprising includes a bleed down block connected to the main fluid line, a first bleed down valve coupled to the bleed down block, and a second bleed down valve coupled to the first bleed down valve. The first pressure relief valve and the second pressure relief valve define a bleed down fluid flow path that extends approximately perpendicular to the primary fluid flow path.

In an embodiment, the first bleed down valve is a normally open gate valve, and the second bleed down valve is a normally closed gate valve.

In an embodiment, the bleed down valve system also includes an adapter connected to the second bleed down valve, wherein the adapter comprises a flow restricting choke, which may be a fixed orifice choke bean or an adjustable orifice choke.

In an embodiment, the bleed down valve system also includes a bleed down transducer configured to measure pressure levels within the bleed down block.

In an embodiment, the executable instructions, when executed by the processor, further cause the processor to trigger opening of the second bleed down valve and trigger subsequent opening of the first bleed down valve.

In an embodiment, the bleed down valve system may include additional bleed down valves in series with the first and second bleed down valves.

In an embodiment, the bleed down valve system may include a single bleed down valve that is a normally closed gate valve.

In an embodiment, the bleed down valve system may include one or more bleed down valves connected to the side of the bleed down block in an approximately horizontal configuration.

In another aspect, an intelligent valve system is disclosed and configured for placement along a main fluid line of a hydraulic fracturing system, where the main fluid line defines a primary fluid flow path. The intelligent valve system includes a bleed down valve system for venting residual pressure from the main fluid line. The bleed down valve system includes a bleed down block connected to the main fluid line, a first bleed down valve coupled to the bleed down block, and a second bleed down valve coupled to the first bleed down valve. The first bleed down valve and the second bleed down valve define a bleed down fluid flow path that extends approximately perpendicular to the primary fluid flow path.

In an embodiment, the intelligent valve system also includes a pressure relief valve system for releasing pressure from the main fluid line, where the pressure relief valve system uses a pressure relief block connected to the main fluid line, a first pressure relief valve coupled to the pressure relief block, and a second pressure relief valve coupled to the first pressure relief valve. The first pressure relief valve and the second pressure relief valve define an alternative fluid flow path that extends approximately perpendicular to the primary fluid flow path. Either the first pressure relief valve or the second pressure relief valve is positioned as a closed-configuration valve under standard pressurization conditions

In an embodiment, the intelligent valve system also includes a control system having a memory and a software module stored in the memory. The software module houses executable instructions that, when executed by the processor, cause the processor to a) trigger opening of the closed-configuration valve when a measured pressure level at the pressure relief block exceeds a predetermined pressure threshold, and b) trigger closing of either the first pressure relief valve or the second pressure relief valve when the measured pressure level is lower than the predetermined pressure threshold. Alternatively, the executable instructions, when executed by the processor, cause the processor to a) trigger opening of the second bleed down valve and b) trigger subsequent opening of the first bleed down valve.

In yet another aspect, a method for controlling pressure events at a wellsite is disclosed. The method involves positioning a pressure relief valve system along a main fluid line that defines a primary fluid flow path at the wellsite. The pressure relief valve system is configured to release pressure from the main fluid line and uses a pressure relief block connected to the main fluid line, a first pressure relief valve coupled to the pressure relief block, and a second pressure relief valve coupled to the first pressure relief valve, where the first pressure relief valve and the second pressure relief valve define an alternative fluid flow path that extends approximately perpendicular to the primary fluid flow path. The method further involves steps of measuring a pressure level in the pressure relief block, comparing the measured pressure level to a predetermined pressure threshold, and triggering either the first pressure relief valve or the second pressure relief valve to open when the measured pressure level exceeds a predetermined pressure threshold.

In an embodiment, the method also involves positioning a bleed down valve system along the main fluid line for venting residual pressure. The bleed down valve system includes a bleed down block connected to the main fluid line, a first bleed down valve coupled to the bleed down block, and a second bleed down valve coupled to the first bleed down valve, where the first bleed down valve and the second bleed down valve define a bleed down fluid flow path that extends approximately perpendicular to the primary fluid flow path. The method further involves terminating a fracking operation through the main fluid line, triggering the second bleed down valve to open, and triggering the first bleed down valve to open after the second bleed down valve.

### BRIEF DESCRIPTION OF THE DRAWINGS

FIG. 1 is a perspective view of a hydraulic fracturing system in accordance with exemplary embodiments.

FIG. 2 is a front view of an intelligent valve system used in the hydraulic fracturing system of FIG. 1.

FIG. 3 is a front view of a pressure relief valve system for the intelligent valve system of FIG. 2

FIG. 4 is a perspective view of the pressure relief valve system of FIG. 3.

FIG. 5 is a top view of the pressure relief valve system of FIG. 4.

FIG. 6 is a flow diagram of a process of engaging a pressure relief valve system for pressure relief in accordance with exemplary embodiments.

FIG. 7 is a front view of a bleed down valve system for the intelligent valve system of FIG.

FIG. 8 is a perspective view of the bleed down valve system of FIG. 7.

FIG. 9 is a top view of the bleed down valve system of FIG. 8.

FIG. 10 is a side view of the bleed down valve system of FIG. 9.

FIG. 11 is cross-sectional view of an adaptor with a flow restricting choke for a bleed down valve system in accordance with exemplary embodiments.

FIG. 12 is a flow diagram of a process of engaging a bleed down valve system for residual pressure venting in accordance with exemplary embodiments.

FIG. 13 is a perspective view of an alternative embodiment of a pressure relief valve system, or alternatively, a bleed down valve system.

FIG. 14 is a perspective view of an alternative embodiment of a pressure relief valve system, or alternatively, a bleed down valve system.

FIG. 15 is a perspective view of an alternative embodiment of a pressure relief valve system, or alternatively, a bleed down valve system.

FIG. 16 is a top perspective view of an alternative embodiment of a pressure relief valve system, or alternatively, a bleed down valve system.

### WRITTEN DESCRIPTION

While this invention is susceptible to embodiment in many different forms, there are shown in the drawings and will herein be described in detail some specific embodiments of the invention. It should be understood, however, that the present disclosure is to be considered an exemplification of the principles of the invention and is not intended to limit the invention to the specific embodiments so described.

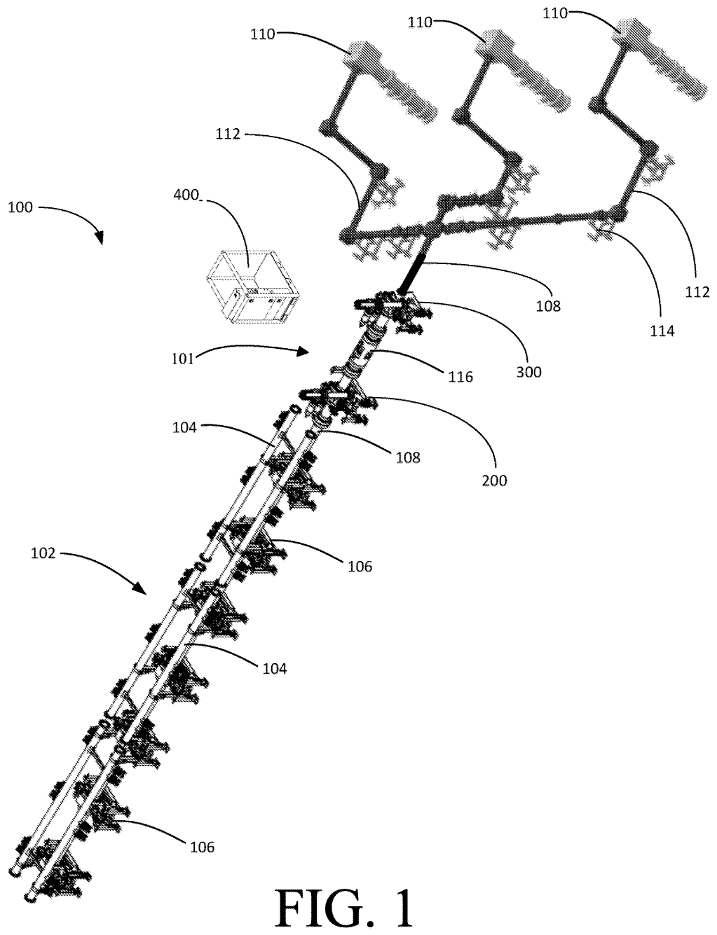

Referring first to FIG. 1, a perspective view of a hydraulic fracturing system 100 is shown, as implemented with an intelligent valve system 101 at a hydraulic fracturing site (or wellsite). As depicted, the intelligent valve system 101 may include a pressure relief valve system 200 and a bleed down valve system 300, which are under the common control of an electronic control system 400 that is used to set, close, monitor, record, bleed off, and reseal various components of the intelligent valve system 101. Although the intelligent valve system 101 is depicted with one pressure relief valve system 200 and one bleed down valve system 300, it will be understood that the intelligent valve system 101 may instead be configured with only the pressure relief valve system 200, only the bleed down valve system 300, or more than one of or combinations of each.

In one embodiment, each pressure relief valve system 200 and bleed down valve system 300 of the intelligent valve system 101 is installed on a separate skid. As such, the systems 200, 300 may be incorporated with the hydraulic fracturing system 100 independently and replaced or maintained separately. In other embodiments, each pressure relief valve system 200 and bleed down valve system 300 is integrated with the hydraulic fracturing system 100.

In general, the hydraulic fracturing system 100 includes a pump manifold system 102 positioned downstream from one or more fracturing pumps (not shown), where the pump manifold system 102 has a plurality of manifold pipes 104 that are supported by pump manifold stands 106. The hydraulic fracturing system 100 also includes a main fluid line 108 that is configured to deliver fracturing fluid from the pump(s) to one or more wellheads 110 through a system of wellhead pipes 112, optionally supported by wellhead manifold stands 114. The main fluid line 108 optionally includes one or more check valves 116. The intelligent valve system 101 (as depicted, including the pressure relief valve system 200 and the bleed down valve system 300) is positioned between the pump manifold system 102 and the wellheads 110.

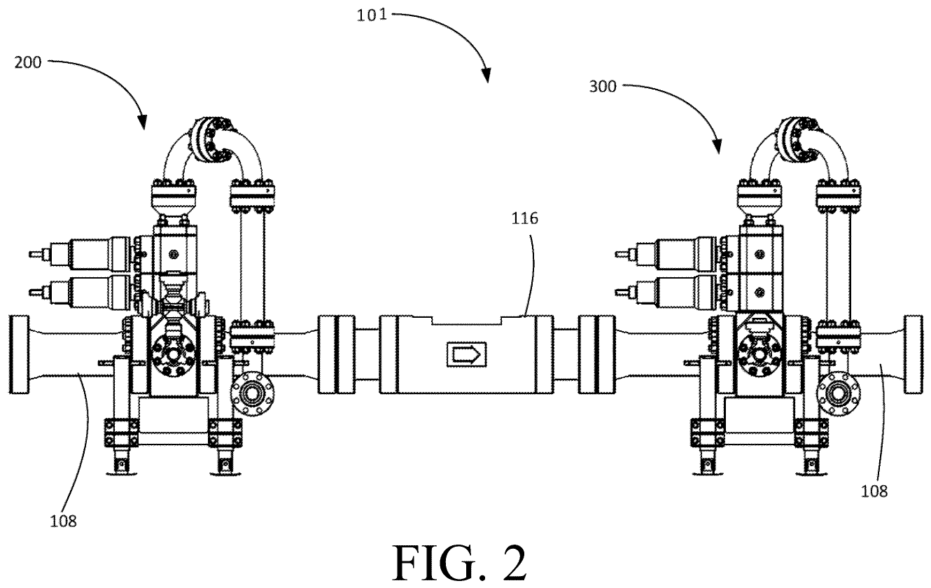

FIG. 2 depicts a front view of the intelligent valve system 101 of FIG. 1. The pressure relief valve system 200 and bleed down valve system 300 are each installed along the main fluid line 108 and separated by a check valve 116. Preferably the pressure relief valve system 200 is positioned upstream of the check valve 116 to prevent fluids from the one or more wellheads 110 (depicted in FIG. 1) from flowing back if the valves in the pressure relief valve system 200 are open. It will be appreciated that, in some embodiments, both the pressure relief valve system 200 and the bleed down valve system 300 are positioned upstream of the check valve 116. It will also be understood that various configurations could be used in the intelligent valve system 101, including one or more pressure relief valve systems upstream or downstream of the check valve 116, one or more bleed down valve systems upstream or downstream of the check valve 116, or combinations of one or more of each upstream or downstream of the check valve 116.

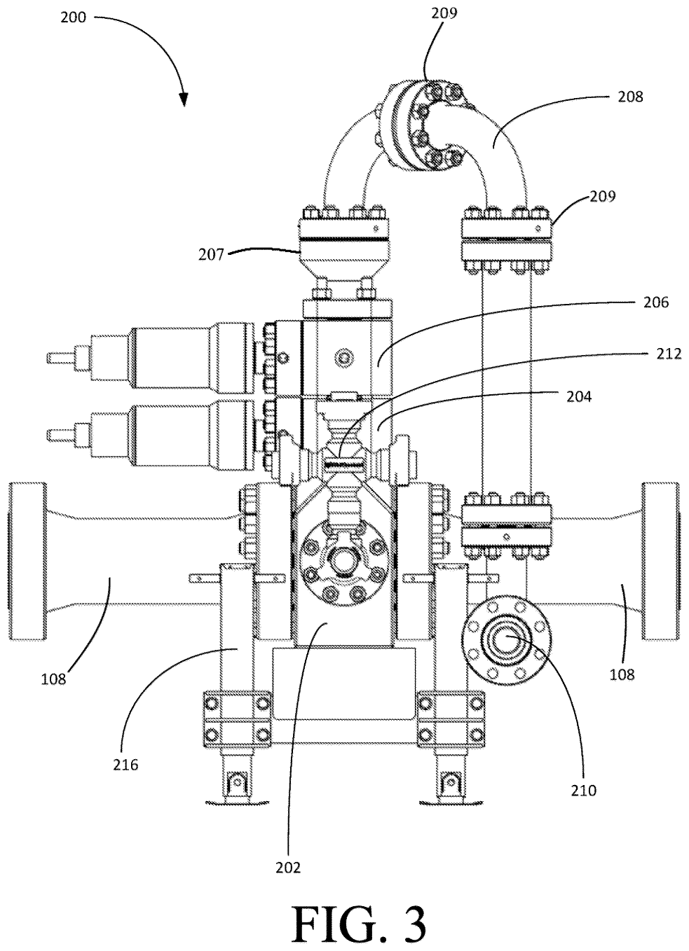

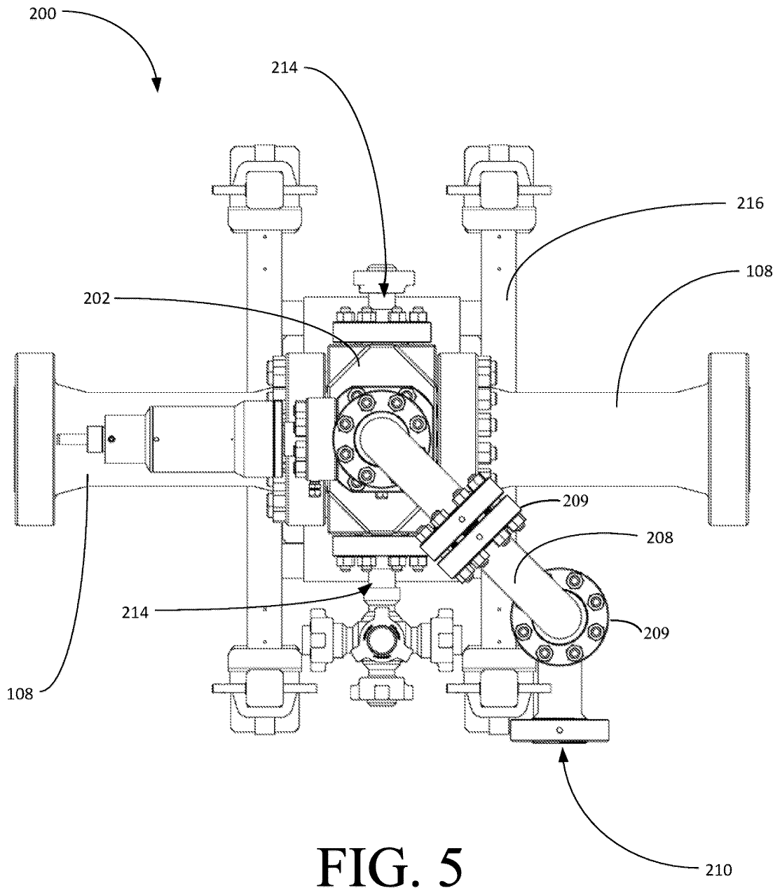

Turning to FIGS. 3-5, the pressure relief valve system 200 receives fluid (such as high-pressure proppant-laden frac fluid) as it flows from the pump manifold system 102, through a section of the main fluid line 108, and into a pressure relief block 202 of the pressure relief valve system 200. The pressure relief block 202 is shown as a 5-way block but any block configuration including a 3-way or more way block configuration may be used. The pressure relief block 202 is connected at opposing ends (depicted as the left and right sides of the pressure relief block 202 in FIGS. 3 and 5) to sections of the main fluid line 108, thereby defining a primary fluid flow path through the pressure relief valve system 200. Above this primary fluid flow path, an alternative fluid flow path is provided through a first pressure relief valve 204, which may be coupled to the top of the pressure relief block 202.

A second pressure relief valve 206, which is fully redundant, may be coupled to the top of the first pressure relief valve 204. The use of two pressure relief valves 204, 206 permits the pressure relief valve system 200 to continue to operate if one of the pressure relief valves 204, 206 is damaged or otherwise fails. In one embodiment, the first and second pressure relief valves 204, 206 are gate valves (i.e., sluice valves). Further, the first and second pressure relief valves 204, 206 may be normally open gate valves. As used herein, the term “normally open” refers to a valve that remains open and permits flow in the absence of a power input, whereas the term “normally closed” refers to a valve that remains closed and prohibits flow without power.

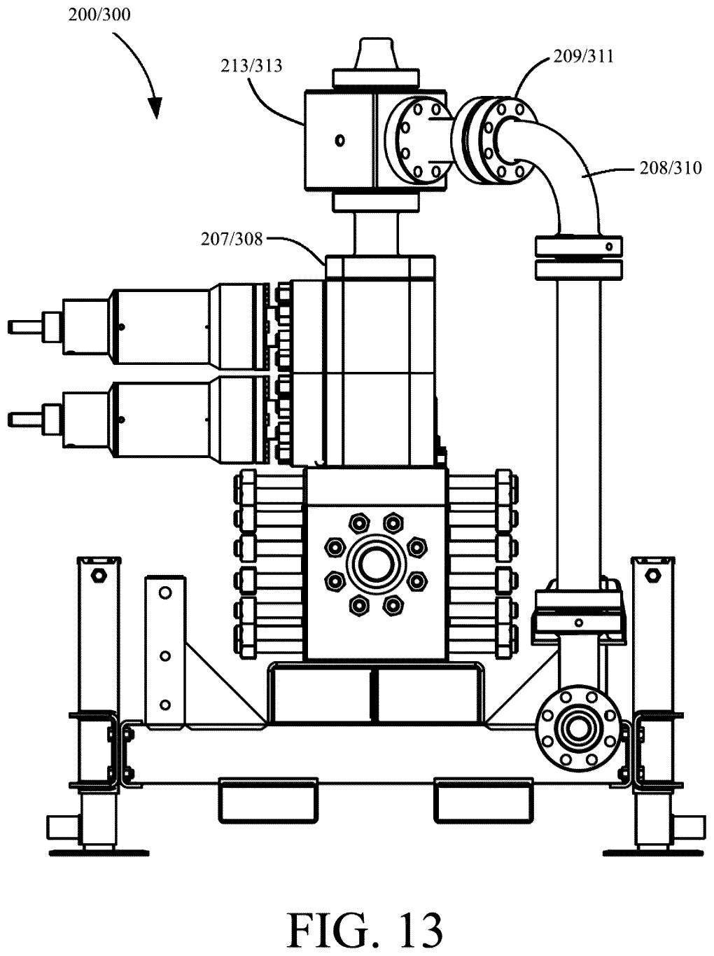

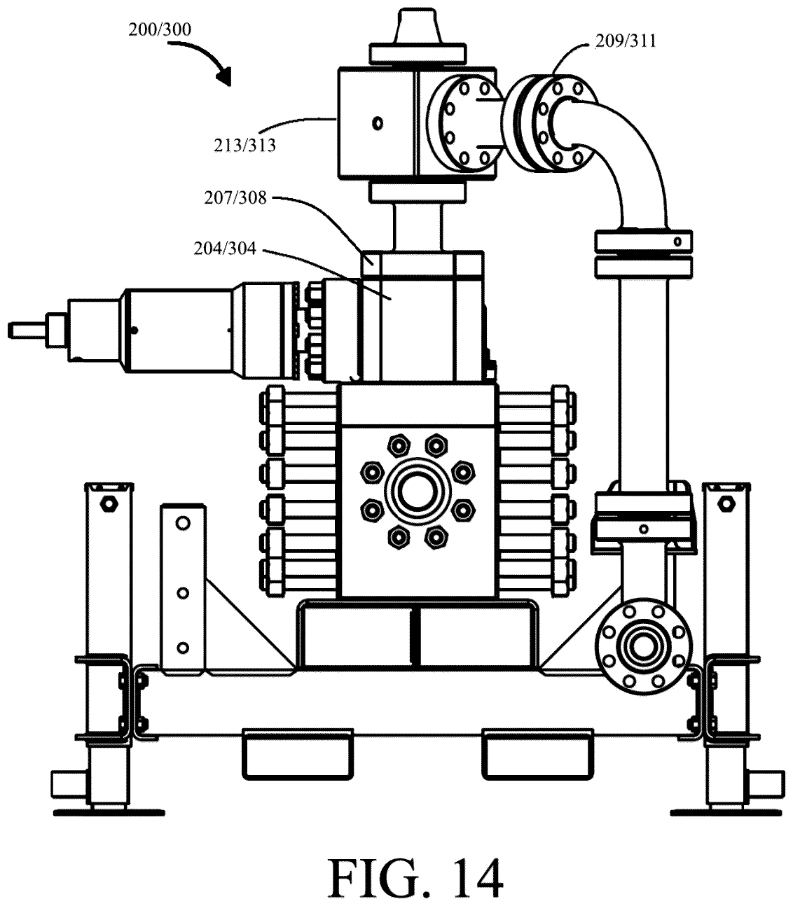

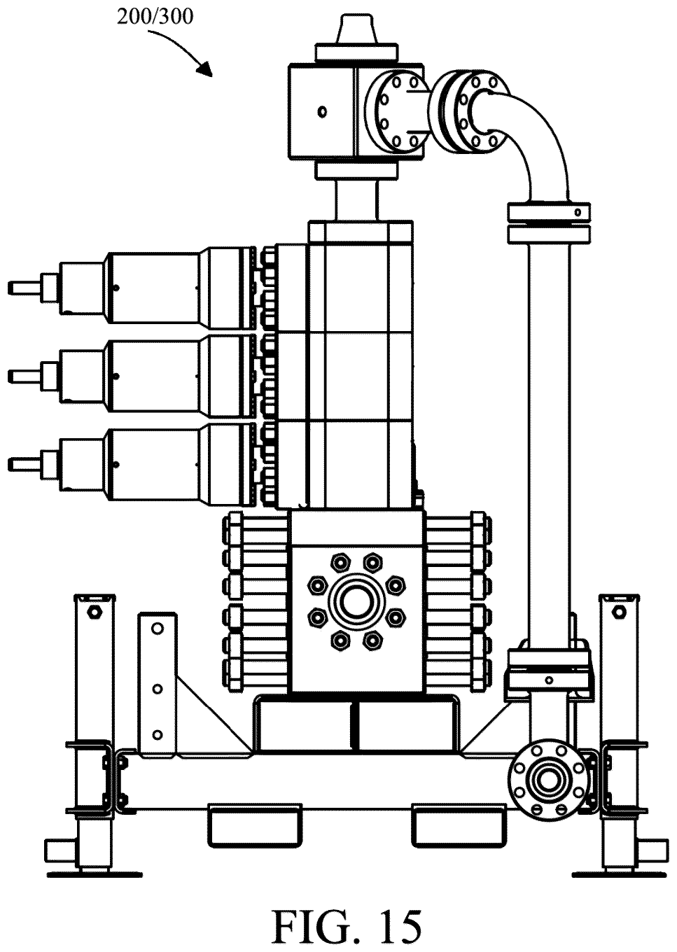

As further depicted in FIGS. 2-5 and 13-15, a pressure relief adaptor 207 may be connected to the top of the second of the pressure relief valve 206. The pressure relief adaptor 207 may be a full flow adaptor. A pressure relief conduit 208 may be connected at one end to the top of the pressure relief adaptor 207 and at the other end to a pressure relief outlet 210. The pressure relief conduit 208 may be configured to include one or more conduit joints 209 or alternatively may include a conduit block 211 (depicted in FIGS. 13-16).

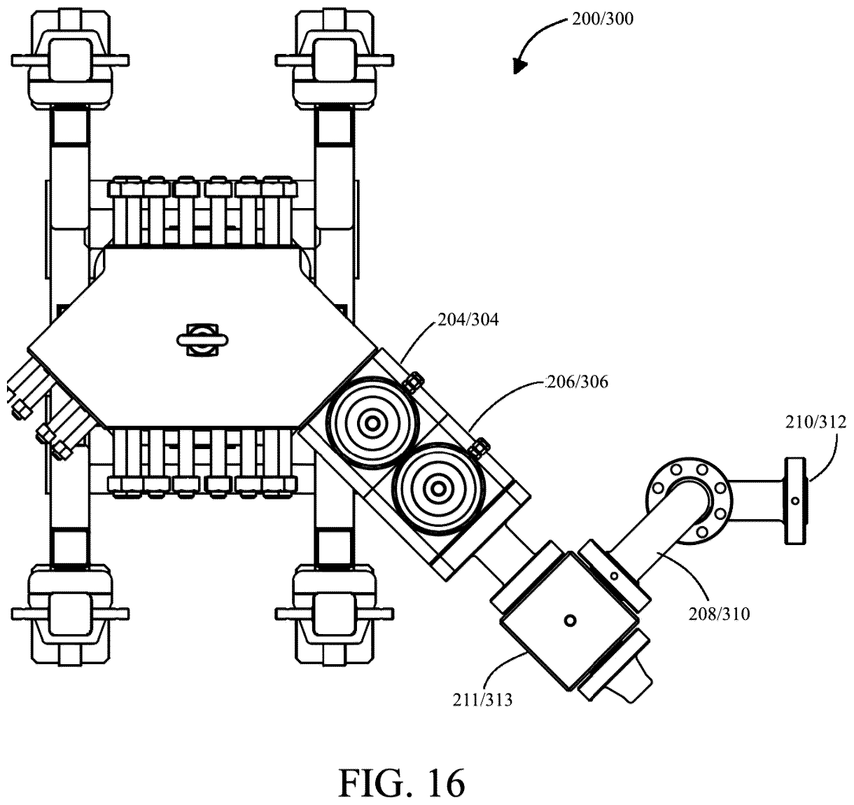

As depicted in FIGS. 13-15, it will be understood that the pressure relief valve system 200 may alternatively include a third pressure relief valve, or alternatively only one pressure relief valve. Additionally, as depicted in FIG. 16, the pressure relief valve system may be configured in an approximately horizontal configuration, such that the first and second pressure relief valves are mounted to a side of the pressure relief block 202. It will be understood that additional pressure relieve valves may be connected in series and may be arranged in less than completely horizontal or vertical configurations.

The alternative fluid flow path extends from the pressure relief block 202 through the first pressure relief valve 204, through the second pressure relief valve 206, through the pressure relief conduit 208, and terminates at the pressure relief outlet 210. The pressure relief outlet 210 can be vented to atmosphere or run to a tank (not shown). One or more adaptors (not shown) may be used to rig the pressure relief valve system 200 in return-to-tank configuration, relief to atmosphere configuration, and other outlet options known in the field.

By positioning the alternative fluid flow path above or beside the primary fluid flow path, fluid continuously circulates through the main fluid line 108 when the first and second pressure relief valves 204, 206 are opened. The vertical or horizontal positioning of the pressure relief valves 204, 206 on the top or side of the pressure relief block 202 also prevents sand and other debris from accumulating ahead of the pressure relief valves 204, 206 due to gravity and separation from the line, thereby increasing the pressure relief valve's system's longevity and reliability.

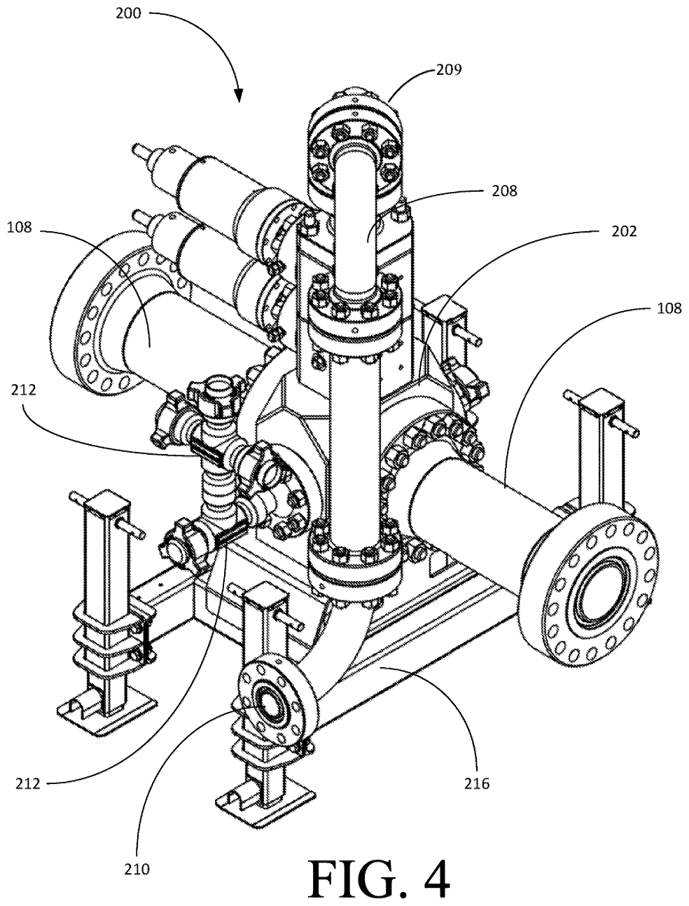

Turning back to the pressure relief block 202, one or more pressure relief transducers 212 may be used to evaluate the levels of pressure experienced within the pressure relief valve system 200. The transducers 212 may be installed directly onto the pressure relief block 202. In various embodiments, transducers 212 are installed using fittings attached to a pressure relief access port 214 of the pressure relief block 202 or a dedicated connection machined into the pressure relief block 202 for said purpose. Multiple transducers 212 may be used to prevent unintentional popoff of the pressure relief valves 204, 206 by cross-examining signals from each other and throwing out errant spike signals. In one embodiment, signals from multiple transducers 212 are averaged to mitigate instrument drift. As best illustrated in FIG. 4, an exemplary pressure relief valve system 200 includes two transducers 212. However, it will be understood that a single transducer or a plurality of transducers (more than two) may be used as needed to measure pressure events.

The transducers 212 are connected via cables or through a wireless connection to the control system 400 and may communicate with the control system 400 as the transducers 212 measure the pressure levels at the pressure relief block 202.

In one embodiment, the pressure relief valve system 200 is supported by a pressure relief valve skid 216.

In various embodiments, under standard pressurization conditions, only one of the pressure relief valves 204 is positioned in a closed configuration, while the other pressure relief valve 206 is left in an open configuration. Where the pressure relief valves 206 are normally open gate valves, power is supplied to the pressure relief valve system 200 to close the valves. Although the foregoing description identifies the closed-configuration valve as pressure relief valve 204 and the open-configuration valve as pressure relief valve 206, it will be appreciated that pressure relief valve 206 may alternatively serve as the closed-configuration valve during an exemplary operation, with pressure relief valve 204 serving as the redundant open-configuration valve.

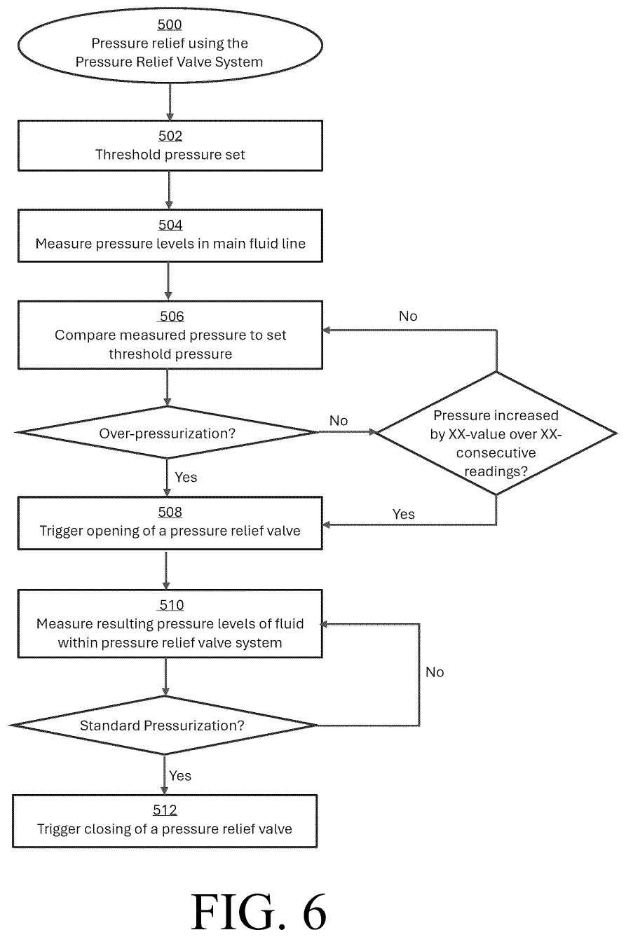

As illustrated in the exemplary process 500 of FIG. 6, The electronic control system 400 is used to set a desired pressure threshold (step 502), then as fluid flows through the pressure relief valve system 200, the transducers 212 measure the pressure levels experienced within the pressure relief block 202 and main fluid line 108 (step 504). Then, in step 506, the pre-determined/set threshold is compared to the measured pressure level. If there is an over-pressurization event (i.e., in which the measured pressure level exceeds the pre-determined pressure threshold), the system determines whether the pressure has increased by a preset value over a preset number of consecutive readings. If it has not, then the process returns to step 506, but if it has increased, then the transducers 212 trigger the closed-configuration valves 204 to open (step 508). Fluid flows through both pressure relief valve 204 (triggered open at step 508) and pressure relief valve 206 (already in open configuration during standard pressurization conditions), into the pressure relief conduit 208, and through the pressure relief outlet 210. The diversion of fluid through this alternative fluid flow path reduces pressure levels experienced at the primary fluid flow path within the pressure relief block 202 and main fluid line 108.

In one embodiment, the pressure relief valve 204 is automatically reset in a closed position after the pressure levels are lowered. For example, at step 510, the transducers 212 measure the resulting pressure levels when the pressure relief valves 204, 206 are opened. If the measured resulting pressure levels fall below the pre-determined pressure threshold (i.e., indicate standard pressurization conditions), the pressure relief valve 204 is triggered to close (step 512). If the measured resulting pressure levels exceed the pre-determined pressure threshold, the transducers 212 continue to monitor and measure the resulting pressures and, in some instances, the computing system 400 is prompted to initiate alternative or supplementary pressure relief. In another embodiment, an operator manually resets the pressure relief valve 204 when it is determined that standard pressurization conditions have been achieved. It will be appreciated that, for either automatic or manual resets, the same pressure relief valve 204 may be returned to the closed configuration or the other pressure relief valve 206 (previously left in open configuration) is placed into the closed configuration. After the pressure relief valve system 200 is reset for standard pressurization conditions, the process may be returned to step 502 to continue monitoring pressure levels experienced along the primary fluid flow path.

The closed-configuration valve may also be switched during an active fracturing operation without changing the pressurization conditions. In one embodiment, the open-configuration valve (e.g., pressure relief valve 206) is placed into the closed configuration, and the closed-configuration valve (e.g., pressure relief valve 204) is subsequently placed into the open configuration. During this switch-off, fluid is not permitted to flow into the pressure relief conduit 208.

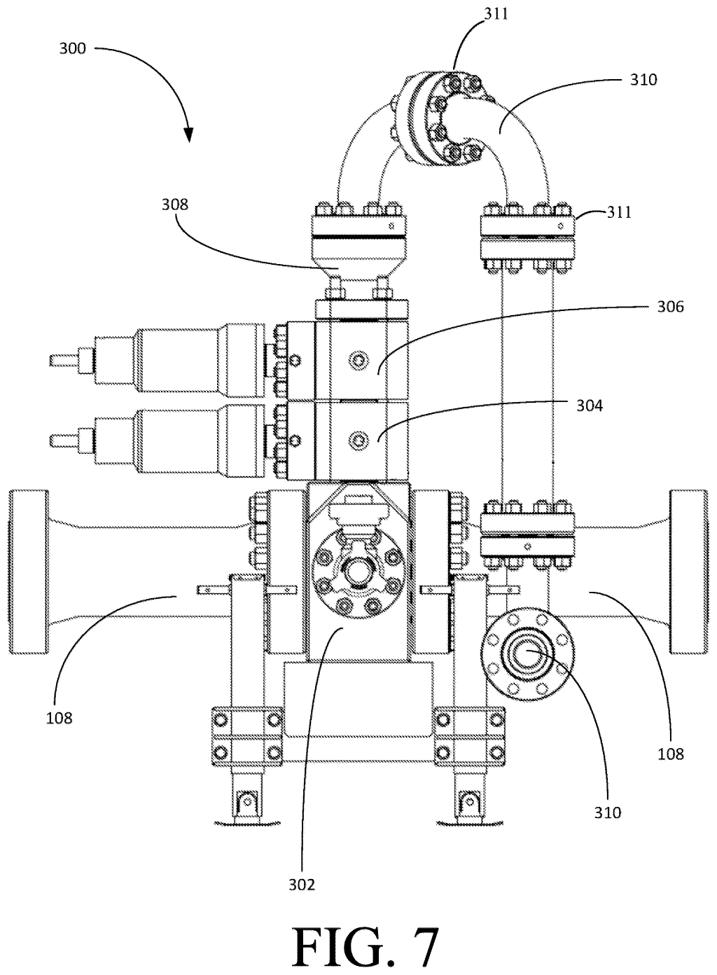

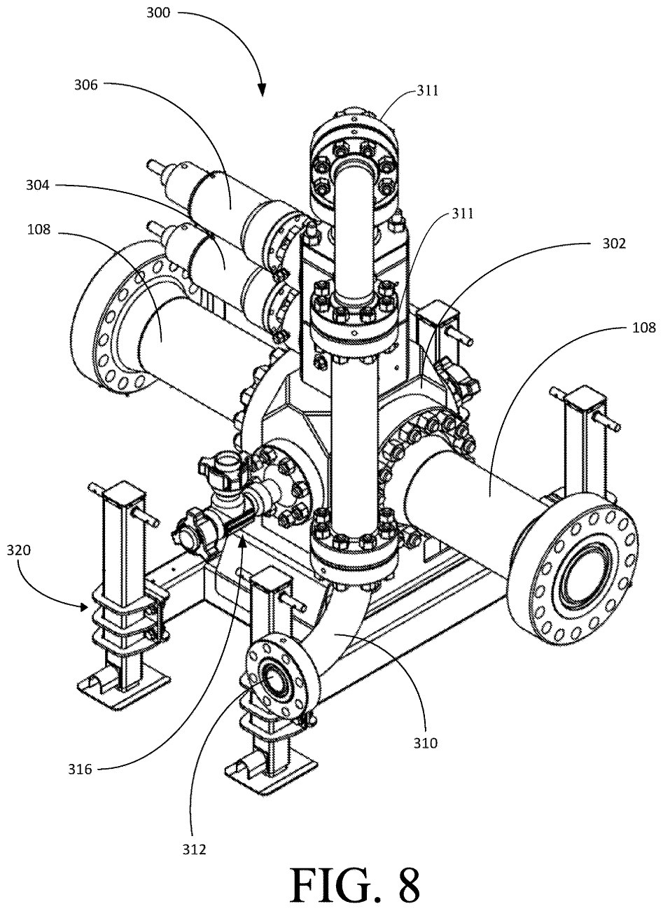

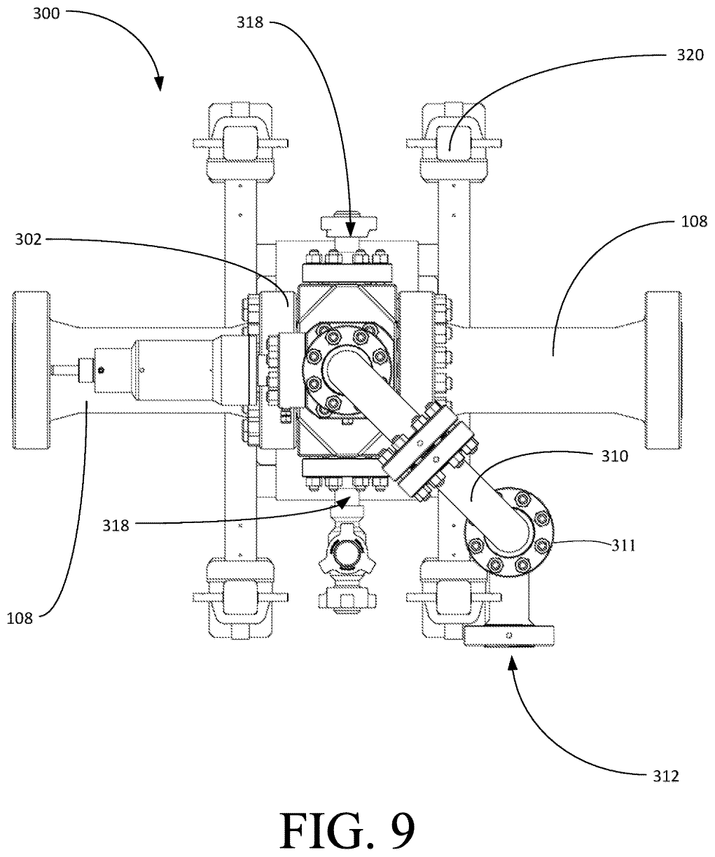

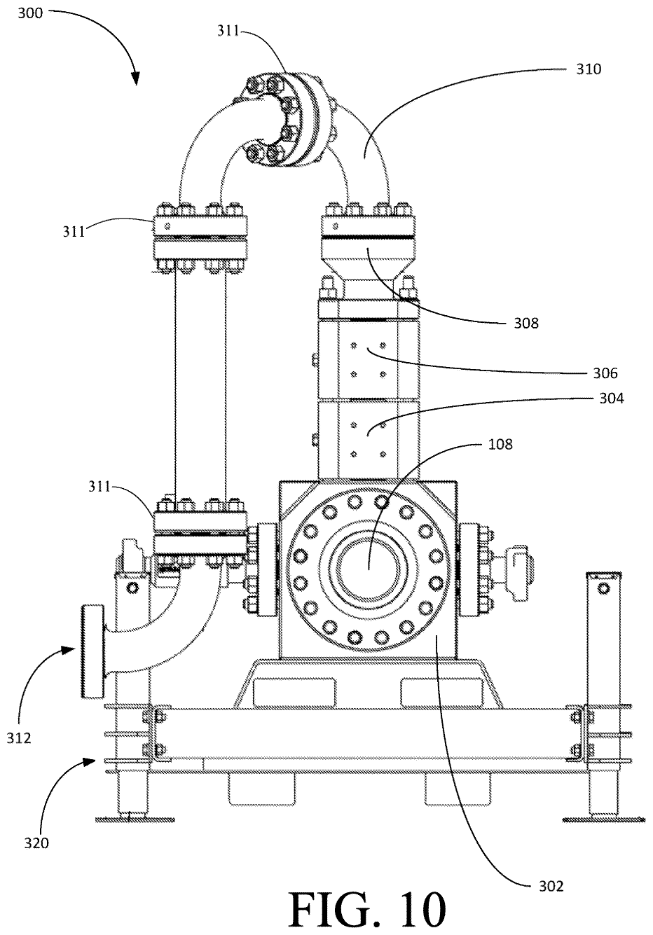

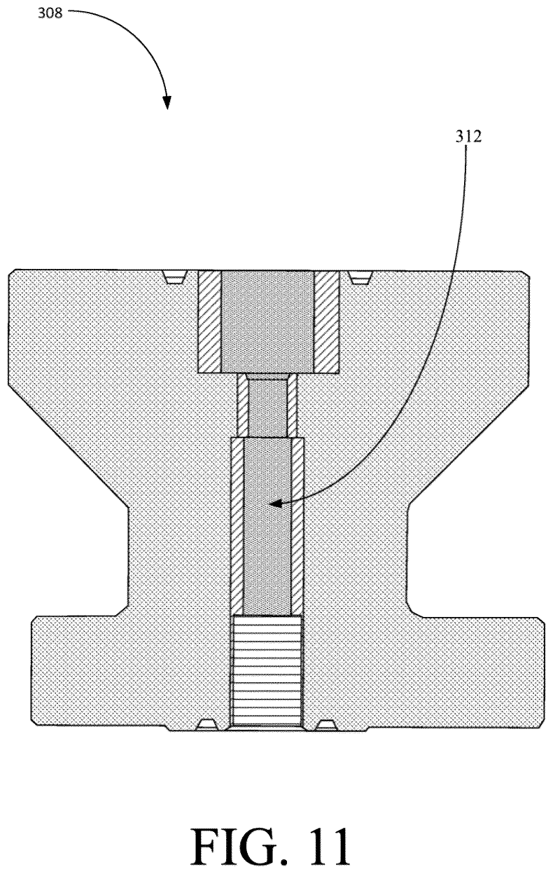

When fracturing operations have terminated, residual pressure from the main fluid line 108 may be vented using the bleed down valve system 300. As shown in FIGS. 7-10, and FIGS. 13-16, the bleed down valve system 300 includes a bleed down block 302, which is coupled at opposing ends to sections of the main fluid line 108 (shown as the left and right sides in FIGS. 6 and 9). The bleed down block 302 is shown as a 5-way block but any block configuration including a 3-way or more way block configuration may be used. A first bleed down valve 304 may be coupled to the top of the bleed down block 302, and a second bleed down valve 306 may be coupled to the top of the first bleed down valve 304. Both bleed down valves 304, 306 may be normally open or normally closed gate valves. In one embodiment, the first bleed down valve 304 is a normally open gate valve, while the second bleed down valve 306 is a normally closed gate valve. An adapter 308 may be installed above the second bleed down valve 306, connecting the bleed down valves 304, 306 to a bleed down conduit 310 that terminates at a bleed down outlet 312, which permits fluid to flow to a tank (not shown). As depicted more fully in FIG. 11, the adapter 308 utilizes a flow restricting chock 314, which may be a fixed orifice choke bean, or an adjustable orifice choke to control the rate of fluid flow into the bleed down conduit 310.

As depicted in FIGS. 13-15, it will be understood that the bleed down valve system 300 may alternatively include a third bleed down valve 307, or alternatively only one bleed down valve. Additionally, as depicted in FIG. 16, the bleed down valve system may be configured in a horizontal configuration, such that the first and bleed down valves (or alternative number, such as one, two, three, or more) are mounted to a side of the bleed down block 302. It will be understood that additional pressure relieve valves may be connected in series and may be arranged in less than completely horizontal or vertical configurations.

The bleed down conduit 310 may be configured to include one or more conduit joints 311 or alternatively may include a conduit block 313 (depicted in FIGS. 13-15).

The vertical positioning of the bleed down valves 304, 306 and the adapter 308 on top or side of the bleed down block 302 prevents sand and other debris from accumulating within and around these components, increasing their longevity and reliability.

Turning back to FIGS. 7-9, an embodiment of the bleed down block 302 includes a bleed down transducer 316. It will be appreciated that more than one bleed down transducer 316 may be connected via the bleed down block 302 in other embodiments. The one or more transducers 316 may be connected using fittings that are attached to one or more of bleed down access ports 318 of the bleed down block 302. The one or more bleed down transducers 316 communicate with the control system 400 via cables or through a wireless connection as the transducer 316 measures the pressure levels within the bleed down valve system 300.

In one embodiment, the bleed down valve system 300 is supported by a bleed down skid 320.

During fracturing operations, fluid (such as high-pressure proppant-laden frac fluid) from the pump manifold system 102 is permitted to flow in and out of the bleed down block 302 along the primary fluid flow path in the main fluid line 108. One or both bleed down valves 304, 306 may be closed for these operations. If the bleed down valves 304, 306 are normally open gate valves, power is input to close them, whereas no power is supplied if the bleed down valves 304, 306 are normally closed gate valves. The use of at least one normally closed gate valve in the bleed down valve system 300 protects from having uncontrolled flow from the well in the event of catastrophe on location preventing operation of primary well protection devices.

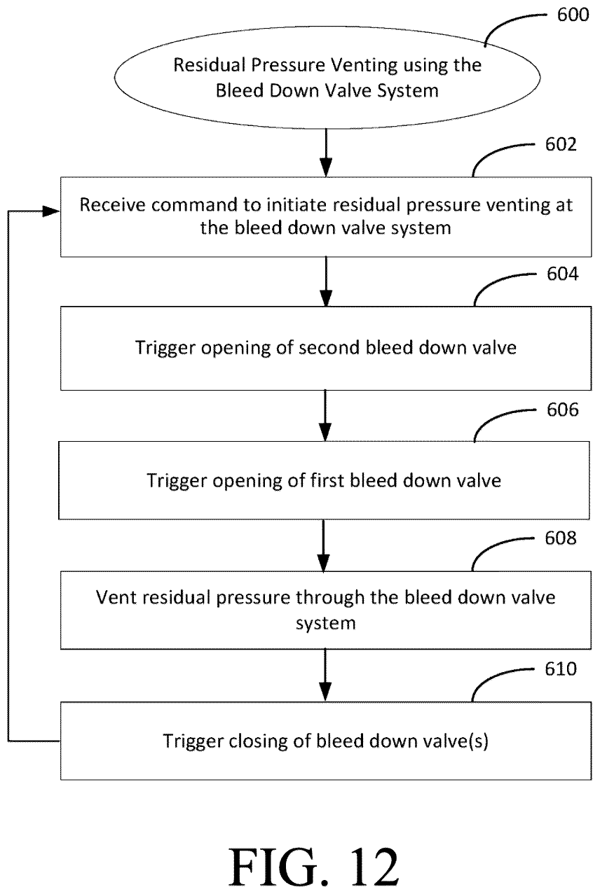

As illustrated in the exemplary process 600 in FIG. 12, when fracturing operations are shut down, the command system 400 provides instructions to the bleed down valve system 300 to open the bleed down valves 304, 306 (step 602). The command system 400 may be programmed to provide these instructions automatically upon terminating fracturing operations or an operator may manually initiate the instructions. In the exemplary process 600, both bleed down valves 304, 306 were closed during fracturing operations, and the second bleed down valve 306 (e.g., a normally closed gate valve) is opened first at step 604, followed by the first bleed down valve 304 (e.g., a normally open gate valve) at step 606. This order of valve opening protects the second bleed down valve 306 from high-pressure impact that would occur if the first bleed down valve 304 were opened first. Fluid then flows through both bleed down valves 304, 306, which define a bleed down fluid flow path that is approximately perpendicular to the primary fluid flow path. The fluid continues to flow through the adapter 308 where it pushes against the flow restricting choke 314, into the bleed down conduit 310, through the bleed down outlet 312, and finally into the tank. When the residual pressure has been sufficiently vented, the bleed down valves 304, 306 may be manually reset by issuing instructions through the command system 400 (step 608). The bleed down valve system 300 is then available to receive future commands to vent residual pressure (return to step 602).

As indicated above, the intelligent valve system 101 may be used in configurations that include only pressure relief valve systems 200, only bleed down valve systems 300, or a combination of both pressure relief valve systems 200 and bleed down valve systems 300. For example, in one embodiment, the intelligent valve system 101 includes only one pressure relief valve system 200. In another embodiment, the intelligent valve system 101 includes one pressure relief valve system 200 and one or more bleed down valve systems 300. In yet another embodiment, the hydraulic fracturing system 100 includes one pressure relief valve system 200, one or more bleed down valve systems 300 upstream from the pressure relief valve system 200, and one or more bleed down valve systems 300 downstream from the pressure relief valve system 200. In each exemplary instance, multiple pressure relief valve systems 200 may be used—in series or at various positions along the main fluid line 108—instead of one to address higher pressure levels or to create redundancies in case one pressure relief valve system 200 becomes inoperable.

It will be appreciated that the bleed down valve system 300 may be used to supplement or replace the pressure relief achieved by the pressure relief valve system 200 during operations. For example, if the pressure relief valve system 200 becomes inoperable during operations, the bleed down valve system 300 may be used in its place to address an over-pressurization event. If the measured pressure levels at the pressure relief valve system 200 continue to exceed the pre-determined pressure threshold after the pressure relief valves 204, 206 have been opened, the bleed down valve system 300 may also be initiated—automatically or manually—to open the bleed down valves 304, 306 and relieve additional pressure.

As noted above, the intelligent valve system 101 and methods 500, 600 may be implemented with the control system 400 which uses hardware, software, firmware, tangible computer readable media having instructions stored thereon, or a combination thereof and may be implemented in one or more computer systems or other processing systems.

If programmable logic is used, such logic may execute on a commercially available processing platform or a special purpose device. One of ordinary skill in the art may appreciate that embodiments of the disclosed subject matter can be practiced with various computer system configurations, including multi-core multi-processor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the inventions may be implemented in terms of this example control system 400. After reading this description, it will become apparent to a person skilled in the relevant art how to implement one or more of the inventions using other computer systems and/or computer architectures. Although operations may be described as a sequential process, some of the operations may be performed in parallel, concurrently, and/or in a distributed environment and with program code stored locally or remotely for access by single or multi-processor machines. In addition, in some embodiments, the order of operations may be rearranged without departing from the spirit of the disclosed subject matter.

The processor device may be a special purpose or a general-purpose processor device or maybe a cloud service wherein the processor device may reside in the cloud. As will be appreciated by persons skilled in the relevant art, the processor device may also be a single processor in a multi-core/multi-processor system, such system operating alone or in a cluster of computing devices operating in a cluster or server farm. The processor device is connected to a communication infrastructure, for example, a bus, message queue, network, or multi-core message-passing scheme.

The control system 400 also includes a main memory, for example, random access memory (RAM), and may also include a secondary memory. The secondary memory may include, for example, a hard disk drive or a removable storage drive. The removable storage drive may include a floppy disk drive, a magnetic tape drive, an optical disk drive, a flash memory, a Universal Serial Bus (USB) drive, or the like. The removable storage drive reads from and/or writes to a removable storage unit in a well-known manner. The removable storage unit may include a floppy disk, magnetic tape, optical disk, etc., which is read by and written to by the removable storage drive. As will be appreciated by persons skilled in the relevant art, the removable storage unit includes a computer usable storage medium having stored therein computer software and/or data.

The control system 400 (optionally) includes a display interface (which can include input and output devices such as keyboards, mice, etc.) that forwards graphics, text, and other data from communication infrastructure (or from a frame buffer not shown) for display on a display unit.

In alternative implementations, the secondary memory may include other similar means for allowing computer programs or other instructions to be loaded into the control system 400. Such means may include, for example, the removable storage unit and an interface. Examples of such means may include a program cartridge and cartridge interface (such as that found in video game devices), a removable memory chip (such as an EPROM, PROM, or Flash memory) and associated socket, and other removable storage units and interfaces which allow software and data to be transferred from the removable storage unit to the control system 400.

The control system 400 may also include a communication interface. The communication interface allows software and data to be transferred between the control system 400 and external devices. The communication interface may include a modem, a network interface (such as an Ethernet card), a communication port, a PCMCIA slot, and card, or the like. Software and data transferred via the communication interface may be in the form of signals, which may be electronic, electromagnetic, optical, or other signals capable of being received by the communication interface. These signals may be provided to the communication interface via a communication path. Communication path carries signals, such as over a network in a distributed computing environment, for example, an intranet or the Internet, and may be implemented using wire or cable, fiber optics, a phone line, a cellular phone link, an RF link, or other communication channels.

In this document, the terms “computer program medium” and “computer usable medium” are used to generally refer to media such as removable storage unit, removable storage unit, and a hard disk installed in the hard disk drive. The computer program medium and computer usable medium may also refer to memories, such as main memory and secondary memory, which may be memory semiconductors (e.g., DRAMs, etc.) or cloud computing.

Computer programs (also called computer control logic) are stored in the main memory and/or the secondary memory. The computer programs may also be received via the communication interface. Such computer programs, when executed, enable the control system 400 to implement the embodiments as discussed herein, including but not limited to machine learning and advanced artificial intelligence. In particular, the computer programs, when executed, enable the processor device to implement the processes of the embodiments discussed here. Accordingly, such computer programs represent controllers of the control system 400. Where the embodiments are implemented using software, the software may be stored in a computer program product and loaded into the control system 400 using the removable storage drive, the interface, the hard disk drive, or the communication interface.

Moreover, embodiments of the disclosure may be practiced with other computer system configurations, including hand-held devices, multi-processor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Embodiments of the inventions also may be directed to computer program products comprising software stored on any computer useable medium. Such software, when executed in one or more data processing devices, causes a data processing device(s) to operate as described herein. Embodiments of the inventions may employ any computer-useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the process to be operated in a particular orientation. Terms, such as “connected,” “connecting,” “coupled,” “attached,” “attaching,” “join” and “joining” are used interchangeably and refer to one structure or surface being secured to another structure or surface or integrally fabricated in one piece.

The above description is given by way of example only, and various modifications may be made by those skilled in the art. The above specification, examples, and data provide a complete description of the structure and use of exemplary embodiments. Although various embodiments have been described above with a certain degree of particularity or with reference to one or more individual embodiments, those skilled in the art could make numerous alterations to the disclosed embodiments without departing from the scope of this specification.

What is claimed is:

1. An intelligent valve system configured for placement along a main fluid line of a hydraulic fracturing system, wherein the main fluid line defines a primary fluid flow path, the intelligent valve system comprising:
a pressure relief valve system for releasing pressure from the main fluid line, wherein the pressure relief valve system comprises:
a pressure relief block connected to the main fluid line; and
a first pressure relief valve coupled to the pressure relief block for providing an alternative fluid flow path to the primary fluid flow path.

2. The intelligent valve system of claim 1, wherein the pressure relief valve system further comprises:
a second pressure relief valve coupled to the first pressure relief valve, wherein the first pressure relief valve and the second pressure relief valve define an alternative fluid flow path that extends approximately perpendicular to the primary fluid flow path.

3. The intelligent valve system of claim 2, wherein the first pressure relief valve and the second pressure relief valve are gate valves.

4. The intelligent valve system of claim 3, wherein the first pressure relief valve and the second pressure relief valve are normally open gate valves.

5. The intelligent valve system of claim 2, wherein the pressure relief valve system further comprises a fluid relief conduit that connect the second pressure relief valve to a pressure relief outlet.

6. The intelligent valve system of claim 1, wherein the pressure relief valve system is configured for installation upstream from a check valve of the main fluid line.

7. The intelligent valve system of claim 2, wherein either the first pressure relief valve or the second pressure relief valve is positioned as a closed-configuration valve under standard pressurization conditions.

8. The intelligent valve system of claim 2, wherein the pressure relief valve system further comprises one or more pressure relief transducers configured to measure pressure levels within the pressure relief block.

9. The intelligent valve system of claim 1, further comprising:
a bleed down valve system for venting residual pressure from the main fluid line, the bleed down valve system comprising:
a bleed down block connected to the main fluid line;
a first bleed down valve coupled to the bleed down block; and
a second bleed down valve coupled to the first bleed down valve, wherein the first pressure relief valve and the second pressure relief valve define a bleed down fluid flow path that extends approximately perpendicular to the primary fluid flow path.

10. The intelligent valve system of claim 9, wherein the first bleed down valve is a normally open gate valve, and the second bleed down valve is a normally closed gate valve.

11. The intelligent valve system of claim 9, wherein the bleed down valve system further comprises an adapter connected to the second bleed down valve, wherein the adapter comprises a flow restricting choke.

12. The intelligent valve system of claim 9, wherein the bleed down valve system further comprises a bleed down transducer configured to measure pressure levels within the bleed down block.

13. The intelligent valve system of claim 12, further comprising:
a control system having a memory and a software module stored in the memory, wherein the software module comprises executable instructions that, when executed by the processor, cause the processor to:
receive signals from the pressure relief transducer that represent the measured pressure level;
compare the measured pressure level from the pressure relief transducer to a predetermined pressure threshold; and
trigger opening of the closed-configuration valve when the measured pressure level exceeds the predetermined pressure threshold.

14. The intelligent valve system of claim 13, wherein the executable instructions, when executed by the processor, further cause the processor to:
determine whether the measured pressure level has increased by a predetermined value over a set number of consecutive readings;
receive signals from the pressure relief transducer that represent the resulting pressure level after the first pressure relief valve and the second pressure relief valve are opened; and
trigger closing of either the first pressure relief valve or the second pressure relief valve when the measured pressure level is lower than the predetermined pressure threshold.

15. The intelligent valve system of claim 14, wherein the executable instructions, when executed by the processor, further cause the processor to:
trigger opening of the second bleed down valve; and trigger subsequent opening of the first bleed down valve.

16. An intelligent valve system configured for placement along a main fluid line of a hydraulic fracturing system, wherein the main fluid line defines a primary fluid flow path, the intelligent valve system comprising:
a bleed down valve system for venting residual pressure from the main fluid line, the bleed down valve system comprising:
a bleed down block connected to the main fluid line;
a first bleed down valve coupled to the bleed down block; and
a second bleed down valve coupled to the first bleed down valve, wherein the first bleed down valve and the second bleed down valve define a bleed down fluid flow path that extends approximately perpendicular to the primary fluid flow path.

17. The intelligent valve system of claim 16 further comprising:
a pressure relief valve system for releasing pressure from the main fluid line, wherein the pressure relief valve system comprises:
a pressure relief block connected to the main fluid line;
a first pressure relief valve coupled to the pressure relief block; and
a second pressure relief valve coupled to the first pressure relief valve, wherein the first pressure relief valve and the second pressure relief valve define an alternative fluid flow path that extends approximately perpendicular to the primary fluid flow path, wherein either the first pressure relief valve or the second pressure relief valve is positioned as a closed-configuration valve under standard pressurization conditions.

18. The intelligent valve system of claim 17, further comprising:
a control system having a memory and a software module stored in the memory, wherein the software module comprises executable instructions that, when executed by the processor, cause the processor to:
ia) trigger opening of the closed-configuration valve when a measured pressure level at the pressure relief block exceeds a predetermined pressure threshold, and ib) trigger closing of either the first pressure relief valve or the second pressure relief valve when the measured pressure level is lower than the predetermined pressure threshold; or
iia) trigger opening of the second bleed down valve, and iib) trigger subsequent opening of the first bleed down valve.

19. A method for controlling pressure events at a wellsite, the method comprising the steps of:
positioning a pressure relief valve system along a main fluid line defining a primary fluid flow path at the wellsite, wherein the pressure relief valve system is configured to release pressure from the main fluid line and comprises:
a pressure relief block connected to the main fluid line;
a first pressure relief valve coupled to the pressure relief block; and
a second pressure relief valve coupled to the first pressure relief valve, wherein the first pressure relief valve and the second pressure relief valve define an alternative fluid flow path that extends approximately perpendicular to the primary fluid flow path;
measuring a pressure level in the pressure relief block;
comparing the measured pressure level to a predetermined pressure threshold; and
triggering either the first pressure relief valve or the second pressure relief valve to open when the measured pressure level exceeds a predetermined pressure threshold.

20. The method of claim 19 further comprising the steps of:
positioning a bleed down valve system along the main fluid line for venting residual pressure, wherein the bleed down valve system comprises:
a bleed down block connected to the main fluid line;
a first bleed down valve coupled to the bleed down block; and
a second bleed down valve coupled to the first bleed down valve, wherein the first bleed down valve and the second bleed down valve define a bleed down fluid flow path that extends approximately perpendicular to the primary fluid flow path;
terminating a fracking operation through the main fluid line; triggering the second bleed down valve to open; and
triggering the first bleed down valve to open subsequent to the second bleed down valve.
